(19) United States
(12) Patent Application Publication
(10) Pub. No.: US 2001/0033077 A1
(43) Pub. Date: Oct. 25, 2001

(54) Tiered memo block

(76) Inventor: Liang-Ji Chen, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,645

(22) Filed: May 17, 2001

Related U.S. Application Data
(63) Continuation-in-part of application No. 09/290,229, filed on Apr. 13, 1999, now Pat. No. 6,254,960.

(51) Int. Cl. B42D 1/00

(52) U.S. Cl. 281/15.1

(57) ABSTRACT

A tiered memo block composed of several tiers of notepapers is provided. Each tier is formed by a plurality of notepapers, and each notepaper is provided with a predetermined protruding pattern at a certain edge position. Several tiers are successively piled up with the protruding portions of each tier being offset one from another, and then one edge surface of several tiers are glued together to form a memo block that is conveniently opened through the use of the protruding pattern portions as tabs.

### CROSS-REFERENCE TO RELATED PATENT APPLICATIONS

This Application is a Continuation-in-Part patent application of patent application Ser. No. 09/290,229, filed Apr. 13, 1999, and entitled MEMO BLOCK.

### BACKGROUND OF THE INVENTION

1. Field of the Invention

The present invention relates to a tiered memo block with innovatory new features, and more particularly to a memo block which is composed by several tiers of notepapers and provided with predetermined patterns protruding on certain edge positions so as to have the effects of being cubic, vivid and convenient for a user to open the memo block or tear a notepaper off.

2. Description of the Related Art

Referring to FIG. 1, a conventional memo block is composed by a pile of straight and regularly cut notepapers, and one side surface of the memo block is glued to form a spine so as for a user to open and look over the memo block. Some designs or advertising words may be provided in each notepaper to make the memo block look more beautiful. However, the conventional memo block still looks dull because it is provided with the same designs from the first notepaper to the last one, and it is not convenient for a user to open the memo block because all of its edge surfaces are smooth.

### SUMMARY OF THE INVENTION

Accordingly, the present invention is directed to a tiered memo block which can substantially obviates the defects of the related conventional memo block.

An object of the present invention is to provide a tiered memo block which is composed by several tiers of notepapers and provided with a predetermined pattern on one edge surface of each tier so as to make the memo block look cubic, vivid and beautiful and to present different patterns tier after tier.

Another object of the present invention is to provide a tiered memo block whose predetermined patterns protruding on the edges are convenient for a user to open and look over the memo block or to tear a notepaper off.

Yet another object of the present invention is to provide a tiered memo block whose several tiers with different patterns can be easily torn apart for a user to choose any tier he/she likes.

To achieve these advantages, a tiered memo block in the present invention is composed by several tiers of notepapers. Each tier is composed by a plurality of notepapers, and each notepaper is provided with a predetermined pattern on a certain edge position. Several tiers are successively piled up, and then the bottom edge surfaces of several tiers are glued together to form a cubic and vivid memo block convenient for being opened through the protrusion of each predetermined pattern.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective view of a conventional memo block;

FIG. 2 is an exploded view of an embodiment of the tiered memo block in accordance with the present invention;

FIG. 3 is a perspective view of an embodiment of the tiered memo block in an assembled configuration in accordance with the present invention;

FIG. 4 is a perspective view of another embodiment of the tiered memo block in accordance with the present invention; and,

FIG. 5 is a perspective view of a further embodiment of the tiered memo block in accordance with the present invention.

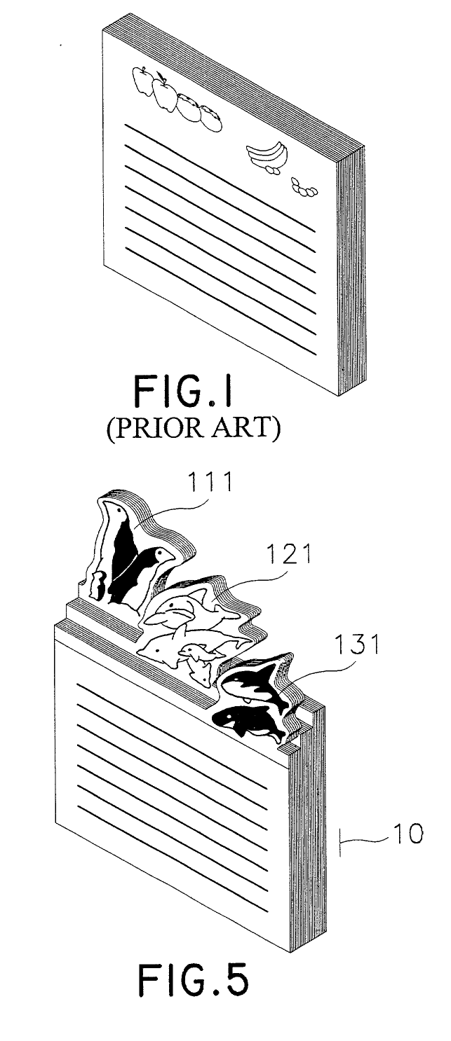

### DETAILED DESCRIPTION OF THE PREFERRED EMBODIMENTS

Reference will now be made in detail to the preferred embodiments of the present invention, examples of which are illustrated in the accompanying drawings.

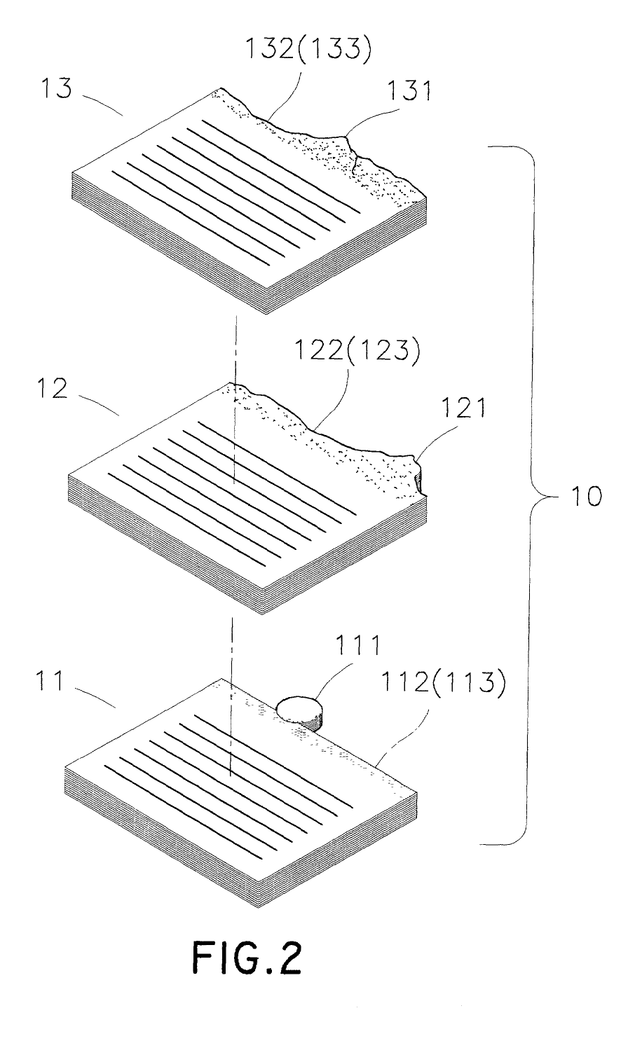

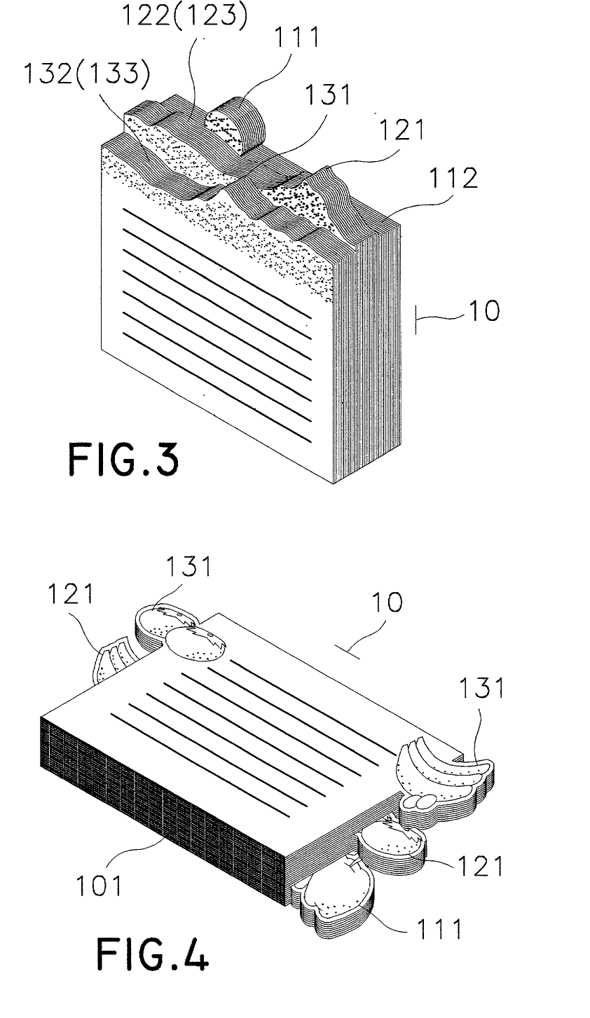

Referring to FIGS. 2, a preferred embodiment of the tiered memo block 10 in the present invention is composed by several tiers of notepapers 11, 12 and 13. Each tier 11, 12 or 13 is composed by a plurality of notepapers. Referring to FIGS. 3,4 and 5, on a certain edge position 112, 122 or 132 of each tier 11, 12 or 13 is provided with a predetermined pattern 111, 121 or 131. The edge surface 112, 122 or 132 of each tier 11, 12 or 13 of the memo block 10 may be smooth 113 or undulated 123, 133 in accordance with each predetermined pattern 111, or 121, 131, as shown in FIG. 3.

While being assembled, several tiers 11, 12 and 13 are successively piled up, and the top edge of each rear tier is higher than that of each front tier so as to have tiered and cubic effects, as shown in FIG. 5. The predetermined patterns 111, 121, 131 on several tiers 11,12,13 of notepapers are properly staggered so as to prevent the patterns on different tiers from being covered by one another because of overlap. At last, the bottom edge surfaces 101, as shown in FIG. 4, of several tiers 11,12 and 13 are glued together to form a tiered, cubic memo block 10 convenient for use.

While the preferred embodiments of the invention have been described above, it will be recognized and understood that various modifications may be made therein and the appended claims are intended to cover all such modifications which may fall within the spirit and scope of the invention.

What is claimed is:

1. A memo block comprising a plurality of memo pad sections arranged one upon another, each of said memo pad sections being formed by a plurality of stacked notepapers, each notepaper of a respective memo pad section having a predetermined protruding pattern formed on at least a first perimeter edge thereof and a linear contour on a second perimeter edge, each of said notepapers being stacked with said predetermined protruding pattern and said second perimeter edge being in respective aligned relationship, said second perimeter edges of said notepapers of said plurality of memo pad sections being in aligned relationship, one memo pad section with respect another, and glued together, said at least one predetermined protruding patterns of said notepapers of one said memo pad section being offset with respect to said predetermined protruding patterns of said notepapers of other of said plurality of memo pad sections for forming tabs to (a) facilitate access to a selected one of said memo pad sections, or (b) facilitate subsequent separation of said plurality of memo pad sections from said memo block into individual memo pads.

2. The memo block as recited in claim where said at least one first perimeter edge of said notepapers of one of said memo pad sections are displaced from said at least one first perimeter edge of said notepapers of an underlying one of said memo pad sections to form said memo block with a stepped tiered contour.
